(19) United States
(12) Patent Application Publication
(10) Pub. No.: US 2019/0250255 A1
(43) Pub. Date: Aug. 15, 2019

(54) METHOD AND SYSTEM FOR TARGETING AND TRACKING AN INTRUDER USING A LASER DETECTION AND RANGING DEVICE

(71) Applicant: Hi-Tee Security Systems Ltd., Beit Elazari (IL)

(72) Inventor: David FRUCHT, Beit Elazari (IL)

(73) Assignee: Hi-Tee Security Systems Ltd., Beit Elazari (IL)

(21) Appl. No.: 16/269,691

(22) Filed: Feb. 7, 2019

(30) Foreign Application Priority Data
Feb. 9, 2018 (GB) GB1802153.5

(51) Int. Cl. G01S 7/481; G01S 17/66; G01S 17/02; G01S 7/48

(52) U.S. Cl. CPC G01S 7/4817; G01S 7/4808; G01S 17/026; G01S 17/66

(57) ABSTRACT

A method and system for targeting and tracking an intruder within a specified volume, which may include the following steps: periodically scanning through a defined zone of coverage with a laser beam produced by at least one laser transmitter, said defined zone of coverage being within said specified volume and adjustable by motion of at least one of a swing mirror or a rotating block; collecting, with at least one laser sensor, reflections of said laser beam reflected from objects within said adjustable defined zone of coverage; applying signal processing algorithms to LADAR signals to determine a presence of an intruder; calculating, in the event of a positive determination of intruder presence, respective orientation parameters of said intruder; and, moving said swing mirror or said rotating block, thereby adjusting said defined zone of coverage, to target said at least one laser transmitter and to track said intruder.

### CROSS REFERENCE TO RELATED APPLICATIONS

This application claims priority of Great Britain Patent Application No. GB1802153.5, filed on Feb. 9, 2018, which is hereby incorporated by reference in its entirety.

### FIELD OF THE INVENTION

The present invention relates generally to targeting and tracking systems, and more particularly, to such systems employing a laser detection and ranging device.

### BACKGROUND OF THE INVENTION

The term “laser detection and ranging” (LADAR) or “light detection and ranging” (LiDAR) is referred herein as a device that measures distance to a target by illuminating that target with light such as a pulsed laser light, and measuring the reflected pulses with a sensor. Differences in laser return times and wavelengths can then be used to make digital representations of the target.

While LADAR devices have become increasingly prevalent in commercial use, they are known to suffer from precision and latency issues and are often unsuitable as standalone surveillance devices. This can be particularly true of situations where there is a considerable surveillance area through which the LADAR device must scan, or where there is a need for immediate real-time intruder detection. In order to improve these precision and latency issues, coverage constraints are often imposed to restrict LADAR devices to scanning smaller zones of control. A consequence of this is that larger surveillance areas invariably require use of a network of interlinked LADAR devices in order to achieve the requisite degree of coverage. This, in turn, significantly impedes practicality and often proves cost prohibitive.

It is therefore an object of the present invention to propose a means by which LADAR targeting and tracking unit coverage may be improved without loss of targeting precision and without increases in tracking latency.

### SUMMARY OF THE INVENTION

Some embodiments of the present invention provide a method and a system for targeting and tracking an intruder within a specified volume. The method may include the following steps: periodically scanning through a defined zone of coverage with a laser beam produced by at least one laser transmitter, said defined zone of coverage being within said specified volume and adjustable by motion of at least one of a swing mirror or a rotating block; collecting, with at least one laser sensor, reflections of said laser beam reflected from objects within said adjustable defined zone of coverage; converting said reflections to LADAR signal indicative of spatiotemporal presence of objects within said specified volume; applying signal processing algorithms to said LADAR signals to determine a presence of an intruder; calculating, in the event of a positive determination of intruder presence, respective orientation parameters of said intruder based on predefined criteria; and, moving said swing mirror or said rotating block, thereby adjusting said defined zone of coverage, to target said at least one laser transmitter and said at least one laser sensor at said orientation parameters and to track said intruder.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a detailed block diagram illustrating a non-limiting exemplary implementation of a swing mirror LADAR detection system in accordance with embodiments of the present invention;

FIG. 2 is a detailed block diagram illustrating a non-limiting exemplary implementation of a rotating block LADAR detection system in accordance with embodiments of the present invention;

FIG. 3 are schematic diagrams illustrating non-limiting exemplary architecture of a swing mirror LADAR detector arrangement in accordance with embodiments of the present invention;

FIG. 4 are schematic diagrams illustrating non-limiting exemplary architecture of a rotating block LADAR detector arrangement in accordance with embodiments of the present invention; and,

FIG. 5 is a high level flowchart illustrating a non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

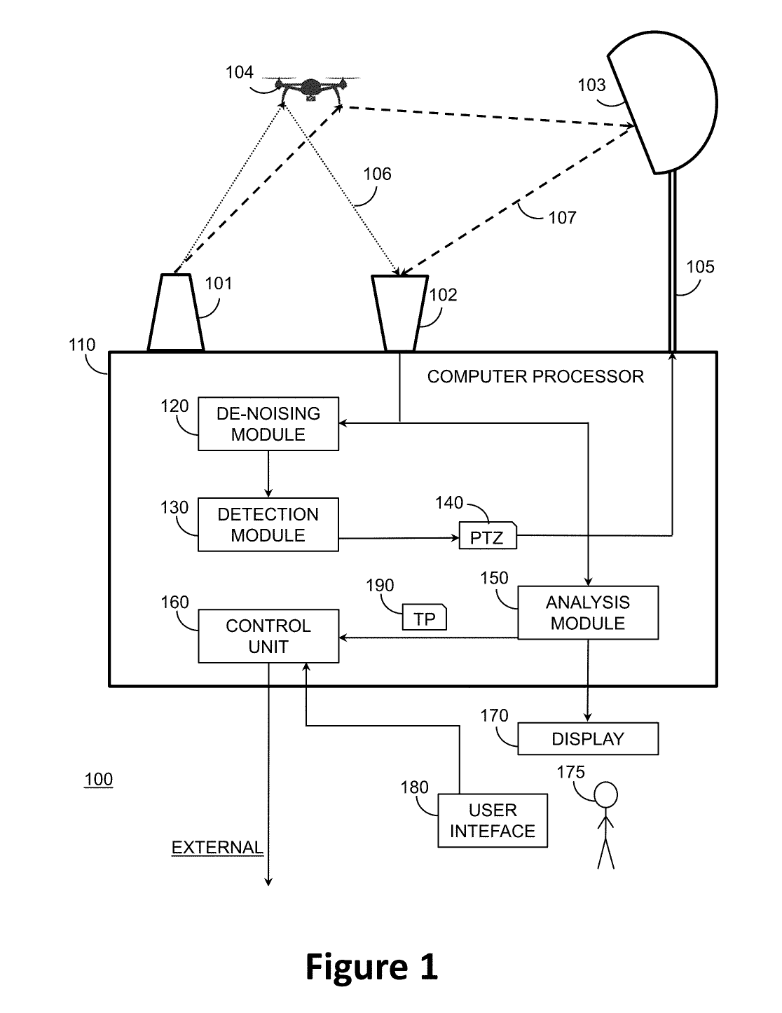

FIG. 1 is a detailed block diagram illustrating a non-limiting exemplary implementation of a swing mirror LADAR detection system in accordance with embodiments of the present invention. According to preferred embodiments, LADAR device 100 may be configured for targeting and tracking an intruder within a specified volume, for example within a volume defined by a sphere or a hemispherical dome. LADAR device 100 may include at least one laser transmitter 101 and at least one laser sensor 102, where each transmitter and sensor pair exhibit a zone of coverage within the specified volume. The dimensions of each zone of coverage may be defined in relation to the scanning frequency of the or each transmitter and sensor pair to ensure precision and low scanning latency. Each zone of coverage may be substantially separate, or may partially or fully overlapped with other zones of coverage for redundancy, consistency and/or contingency.

In operation, each laser transmitter 101 and laser sensor 102 may be configured to periodically scan through a respective defined zone of coverage with a laser beam produced by said at least one laser transmitter 101, said defined zone of coverage being specified within said volume. Further, each laser sensor 102 may be configured to collect reflections of the laser beam arriving from objects within the defined zone of coverage, said reflections arriving from irrelevant objects (not shown) or from a potential intruder 104. Reflections observed at the or each laser sensor 102 may be converted into LADAR signal indicative of the spatiotemporal presence of objects within the specified volume, the LADAR device 100 being operable to ignore reflections originating from objects outside said specified volume. Discrimination between reflections may be achieved by calibrating LADAR device 100 with range thresholds, wherein reflections from objects exceeding said range threshold are deemed to arrive from objects falling outside said specified volume.

LADAR device 100 may further include a computer processor 110 operatively connected to the or each laser transmitter 101 and laser sensor 102, wherein computer processor 110 may be configured to apply signal processing algorithms to the LADAR signals, to determine a presence of an intruder 104 and, in the event of a positive determination of intruder presence, to calculate respective orientation parameters of said intruder based on predefined criteria. In some embodiments, LADAR device 100 may comprise at least one of a swing mirror, said swing mirror being operable to adjust the zone of coverage exhibited by the or each transmitter and sensor pair. The computer processor 110 may be further configured to move said swing mirror, thereby adjusting said defined zone of coverage, to target and/or aim said at least one laser transmitter and said at least one laser sensor at said orientation parameters and to track said intruder.

Reflections from objects within, and potentially from beyond, the specified volume are received at LADAR sensor 102 and are converted into respective LADAR signals. These reflections may arrive, for example, either directly 106 following reflection from an intruder 104, or indirectly 107 following reflection from both the intruder 104 and swing mirror 103. Following conversion, the LADAR signals may be filtered and/or enhanced by a de-noising process implemented by de-noising module 120. The filtered signals may then be assessed by a decision function implemented by detection module 130, the decision function discriminating the processed reflections and determining whether they belong to an intruder or irrelevant target. The discrimination may be made in relation to a threshold, said threshold being one of mobility, range or appearance. In the case they do belong to an intruder, respective orientation (PTZ) parameters 140 associated with the direction and location of the intruder may be derived and may be applied to a driver 105 mechanically coupled to the or each swing mirror.

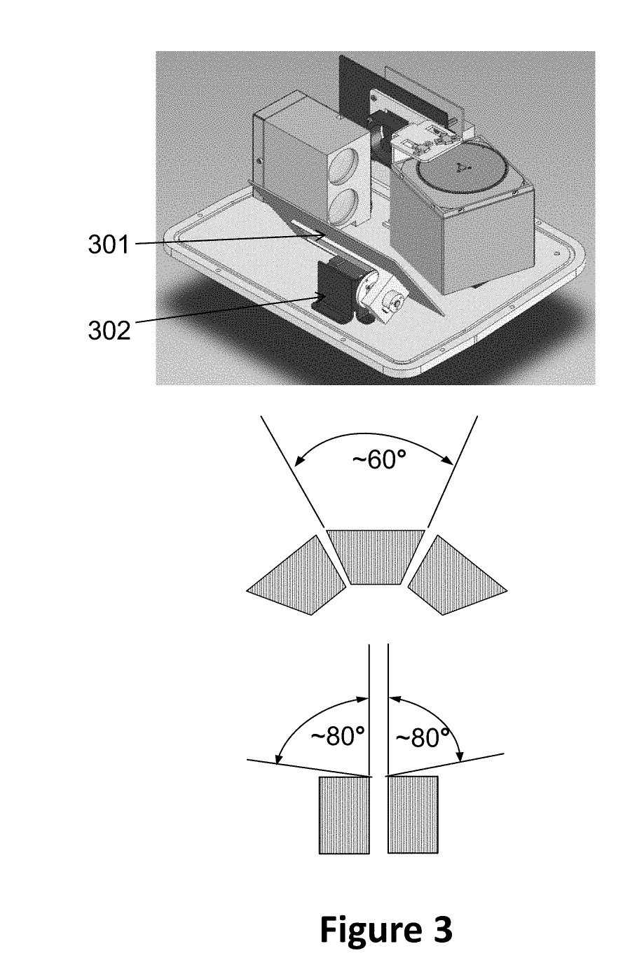

The tilt angle of swing mirror 103, which is described in further detail in the description relating to FIG. 3, may be adjusted by driver 105. This is to say that driver 105 may be actuated by computer processor 110 to adjust the tilt angle of swing mirror 103 and thereby also adjust and vary the zone of coverage exhibited by the or each associated sensor and transmitter pair. Variations to the tilt angle may be made during ordinary scanning procedures to improve coverage, or following intruder detection for the purposes of targeting and tracking said intruder. In the event that an intruder is identified and tracked, raw data concerning the intruder's mobility, appearance, trajectory and bearings may be compiled and stored. This raw data may then be conveyed to an analysis module 150 where further recognition and enhancement may be carried out. Tracking parameters 190 are then derived in real time so that driver 105 may be continually actuated to retain intruder 104 within the zone of coverage exhibited by the or each associated transmitter and sensor pair. The tracking parameters may be conveyed to a control unit 160 for use by an external entity (no shown here). Additionally, analysis module 150 may provide enhanced data to be presented over a display 170 to an operator 175 who can then provide his or her input via a user interface 180 to control unit 160. It will be appreciated by those skilled in the art that each of de-noising module 120, detection module 130, analysis module 150, control unit 160, display 170, user interface 180, laser transmitter 101, and laser sensor 102 may be physically or wirelessly connected to computer processor 110.

The purpose of LADAR device 100 is to illuminate incoming threats, but other objects, such as buildings, are still detected in the form of environmental noise. It will be appreciated by those skilled in the art that it is desirable for this environmental noise to be filtered out so as to reduce clutter and eliminate potential false alarms. It is therefore a task of the processing apparatus to filter out environmental noise by running a dedicated filtering computer program, which may be executed by the computer processor 110, said computer program being stored in a non-transitory computer readable medium. It may thus be said that the filtering program embodied in the computer-readable medium is dedicated to detect a relevant object, such as intruder 104 having the level of danger of being a threat, out of many objects penetrating into or existing within the specified volume scanned by the LADAR device 100. An algorithm implemented by the aforementioned computer readable code may use filtering trends and parameters to calculate variable and/or dynamic discrimination thresholds. For example, if the specified volume is observed to have greater irrelevant target activity during certain times of the day, the discrimination threshold may be adjusted accordingly.

According to some embodiments of the present invention, predefined criteria for determining a presence of an intruder in specific orientation parameters comprise a level of an integral of two of the LADAR signals measured in different times for the specific orientation parameters.

According to some embodiments of the present invention, orientation parameters comprise an orientation a line of sight of the LADAR whenever the line of sight intersects an object determined to be an intruder.

According to some embodiments of the present invention, comprising a control unit configured to instruct an external entity based on the tracking parameters.

According to some embodiments, computer processor 110 may be configured to apply at least one de-noising filter to said LADAR signals prior to determining the presence of the intruder 104.

According to some embodiments, computer processor 110 may be configured to run a dedicated filtering program to filter out environmental noise, said environmental noise being related to static, inanimate or permanent objects within said specified volume.

According to some embodiments, computer processor 110 may be further configured to discriminate said LADAR signals to distinguish between intruders and irrelevant targets, the discrimination being made in relation to a threshold where said threshold is at least one of mobility, range and appearance.

According to some embodiments, said mobility comprises at least one of: speed, acceleration, and vector of advancement, said appearance comprises at least one of: shape, color, and size, and said range is defined in relation to said specified volume.

According to some embodiments, computer processor 110 may be further configured to use filtering trends and parameters to calculate dynamic discrimination thresholds.

According to some embodiments, tracking parameters relating to a determined intruder are derived from raw data concerning said intruder's mobility, appearance, trajectory and bearings.

According to some embodiments, LADAR device 100 may further comprise a display 170, wherein said computer processor 110 is configured to present continuously on said display 170 enhanced data relating to said intruder, said continuous presentation persisting while said intruder is tracked within said specified volume.

According to some embodiments, each laser transmitter 101 and laser sensor 102 pair may be configured to periodically scan through a respective defined 2D zone of coverage with a laser beam produced by said at least one laser transmitter 101, said defined 2D zone of coverage being a portion of an intangible external surface encompassing said volume. Further, each laser sensor 102 may be configured to collect reflections of the laser beam arriving from objects crossing the defined 2D zone of coverage, said reflections arriving from irrelevant objects (not shown) or from a potential intruder 104. Reflections observed at the or each laser sensor 102 may be converted into LADAR signal indicative of the spatiotemporal presence of objects entering the specified volume, the LADAR device 100 being operable to ignore reflections originating from objects outside said specified volume. It will be appreciated by those skilled in the art that scanning through a defined 2D zone of coverage (i.e. a portion of a shell surrounding the specified volume) may be significantly quicker and more energy efficient than scanning through a full defined 3D zone of coverage. Further, if an intruder 104 is detected entering the specified volume, the LADAR device 100 may switch to scanning a defined 3D zone of coverage, or may track the intruder 104 directly within the specified volume.

According to some embodiments, computer processor 110 may be configured to apply black target algorithms to the LADAR signals to detect low reflective targets, said black target algorithms analyzing the contrast between intruder 104 signals and background signals. Black target algorithms may be applied continuously to all obtained LADAR signals, or may be applied only to a sample of signals over a preset or variable sampling period. It will be appreciated by those skilled in the art that ambient conditions, such as ambient weather conditions, may affect target reflectivity. In some embodiments, computer processor 110 may be physically or wirelessly connected to an ambient condition sensor, said ambient condition sensor operable to determine current ambient conditions and to inform said computer processor 110. In some embodiments, black target algorithms may be applied in relation to the determined current ambient condition, said black target algorithms accounting for reflectivity variations arising due to the current ambient condition.

According to some embodiments, zones within the specified volume may be designated with priority bands, said zones having 2D or 3D dimensions. Priority bands may include a no priority, low priority, medium priority, and high priority band, wherein each priority band defines an associated zone scanning frequency and/or intruder 104 determination threshold. In some embodiments, a no priority band may be associated with a zone of limited value within the specified volume, said no priority band defining an absence of scanning, a limited scanning frequency, an absence of intruder 104 detection determination, and/or a substantially increased intruder 104 determination threshold. In some embodiments, a high priority band may be associated with a zone of high value within the specified volume, said high priority band defining increased scanning frequency, continuous scanning, an increased intruder 104 determination threshold, and/or assumed intruder 104 determination. It will be appreciated by those skilled in the art that priority bands may be used to define zones within the specified volume where the presence of an intruder 104 should not raise alarm or flag attention, or where the presence of an intruder 104 highlights a significant or immediate security threat. By associating priority bands with zones within the specified volume, valuable assets may be more attentively protected and unnecessary scanning may be reduced thereby improving LADAR device 100 energy and cost efficiency. The process of associating priority bands with zones within the specified volume may be predominantly or entirely software implemented and may be referred to by those skilled in the art as ‘masking’.

According to some embodiments, zones within the specified volume may be defined by preset, dynamic and/or user variable 2D or 3D co-ordinates, said co-ordinates lying within the specified volume. In some embodiments, said co-ordinates may be established using GPS instrumentation, such GPS locator tags and/or GPS triangulation methodology. In alternative embodiments, zones within the specified volume may be defined by an individual and/or an unmanned ground vehicle (UGV) tracing the boundaries of said zone, said individual or UGV being tracked by GPS and/or by LADAR device 100. In the case of the individual or UGV being tracked by the LADAR device 100, LADAR signals reflected from the individual or UGV may be collected and stored in a signal processing memory device, said signal processing memory device being physically or wirelessly connected to the computer processor 110. It will be appreciated by those skilled in the art that the signal processing memory device may be accessed by the computer processor 110 at any appropriate time to establish the presence and/or boundaries of zones within the specified volume.

According to some embodiments, the beam pulse frequency emitted from laser transmitter 101 and/or the scanning frequency of laser sensor 102 may be dynamically varied in relation to signal discrimination. It will be appreciated by those skilled in the art that the Johnson Criteria applies to LADAR target discrimination. This is to say that a target may be detected (i.e. presence determined) from relatively few LADAR signals (2-3 signals, for example), however orientation (symmetrical, asymmetrical, horizontal or vertical), recognition (type of object e.g. car or person) and identification (discerning object features e.g. specific car, or man versus woman) require successively more LADAR signals to ascertain. By varying the beam pulse and/or scanning frequency following initial target detection, further LADAR signals may be more quickly obtained to facilitate further discrimination of the target. In some embodiments, the beam pulse and/or scanning frequency may be increased and/or decreased during the signal discrimination process following initiate intruder 104 determination. In some embodiments, the beam pulse and/or scanning frequency may be increased and/or decreased when signal discrimination has completed and when the intruder's appearance and mobility have been determined. In some embodiments, the intruder 104 may be tracked by the or each LADAR transmitter 101 and sensor 102 pair until the discrimination process has completed. In some embodiments, the LADAR device 100 may resume standard and/or ordinary scanning procedures following completion of the intruder 104 discrimination process.

According to some embodiments, LADAR device 100 may comprise a signal amplifier and an analogue to digital (A/D) converter. In some embodiments, a signal pulse associated with a prospective intruder 104 (i.e. the signal pulse arising as a result of a beam emitted from transmitter 101 reflecting from an intruder 104 and being detected by sensor 102) may be amplified by the signal amplifier and converted from analogue to digital by the A/D converter. In some embodiments, the processed signal (i.e. the amplified and converted signal) may be assessed in relation to a comparator and peak detector implemented by computer processor 110. In some embodiments, the comparator followed by the time to voltage and A/D measures the time of flight at the instant the signal pulse is detected. This is a measure of the uncorrected range. In some embodiments, the peak followed by the A/D measures signal pulse amplitude. It will be appreciated by those skilled in the art that the uncorrected range depends on pulse amplitude. In some embodiments, the function Racorrected=F(Runcorrected, Amplitude) may be implemented by a signal processing algorithm and/or the computer processor 110 to yield corrected range.

According to some embodiments, LADAR device 100 may comprise or be used in conjunction with one or more of the following: Dr. Frucht Systems Limited (DFSL) Laser Rader technology; DFSL Smart Sense; DFSL AI; DFSL Long Fence Protection; DFSL Vertical and/or Parallel Laser Curtain technology; DFSL Integration Software—ISSC; DFSL Laser Radar (Lidar) Sensors; DFSL 2D Mini-Drone-Detector; DFSL 3D Mini-Drone-Detector; DFSL Anti-Drone; DFSL Flying-Hunter; DFSL Defender; DFSL Know-How; DFSL IPI Software; DFSL Home and Pool Safety; DFSL Land Security; DFSL Algorithms and Installation Procedures; DFSL HLS Products; DFSL PLS200-35/60; DFSL LFS-60/100/130; DFSL PLS 360-60/100; DFSL LFS-160; DFSL 2D-MND-200-48-PTZ; DFSL ALS-200/350; DFSL Over Height Vehicle Laser Detector (OHVLD); and, DFSL Laser Scanner Mobile Case.

According to some embodiments, LADAR device 100 may be used or applied for one or more of the following: securing long fences; securing open areas; securing roof tops; swimmer and ship detection; obstacle avoidance and anti-piracy at sea; marina protection; drone detection; intruder detection; securing infrastructure; drone interception and capture; railway cross road safety; railway track security; train station platform detection; landing aircraft security; securing water reservoirs; power plant repair and construction; creating sterile areas; construction safety; virtual safety curtain; home safety; detection of falling objects; over height vehicle detection; pool safety; and, prison security.

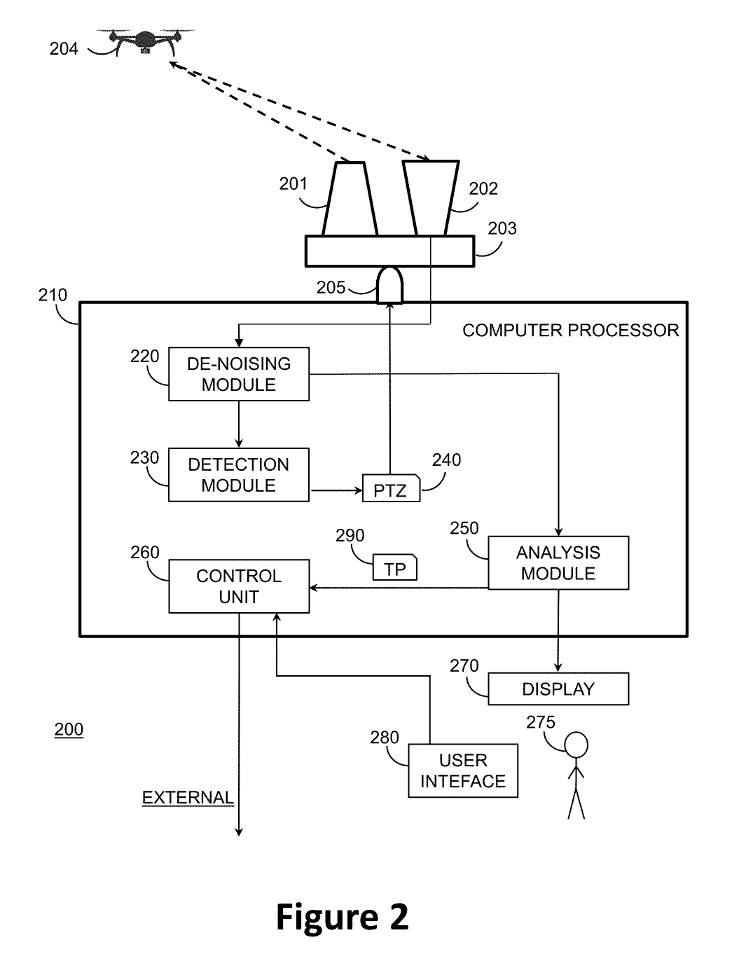

FIG. 2 is a detailed block diagram illustrating a non-limiting exemplary implementation of a rotating block LADAR detection system in accordance with embodiments of the present invention. According to preferred embodiments, LADAR device 200 may be configured for targeting and tracking an intruder within a specified volume, for example within a volume defined by a sphere or a hemispherical dome. LADAR device 200 may include at least one laser transmitter 201 and at least one laser sensor 202, where each transmitter and sensor pair exhibit a zone of coverage within the specified volume. The dimensions of each zone of coverage may be defined in relation to the scanning frequency of the or each transmitter and sensor pair to ensure precision and low scanning latency. Each zone of coverage may be substantially separate, or may partially or fully overlapped with other zones of coverage for redundancy, consistency and/or contingency.

In operation, each laser transmitter 201 and laser sensor 202 may be configured to periodically scan through a respective defined zone of coverage with a laser beam produced by said at least one laser transmitter 201, said defined zone of coverage being specified within said volume. Further, each laser sensor 202 may be configured to collect reflections of the laser beam arriving from objects within the defined zone of coverage, said reflections arriving from irrelevant objects (not shown) or from a potential intruder 204. Reflections observed at the or each laser sensor 202 may be converted into LADAR signal indicative of the spatiotemporal presence of objects within the specified volume, the LADAR device 200 being operable to ignore reflections originating from objects outside said specified volume. Discrimination between reflections may be achieved by calibrating LADAR device 200 with range thresholds, wherein reflections from objects exceeding said range threshold are deemed to arrive from objects falling outside said specified volume.

LADAR device 200 may further include a computer processor 210 operatively connected to the or each laser transmitter 201 and laser sensor 202, wherein computer processor 210 may be configured to apply signal processing algorithms to the LADAR signals, to determine a presence of an intruder 204 and, in the event of a positive determination of intruder presence, to calculate respective orientation parameters of said intruder based on predefined criteria. In some embodiments, LADAR device 200 may comprise at least one rotating block, said rotating block being operable to adjust the zone of coverage exhibited by the or each transmitter and sensor pair. The computer processor 210 may be further configured to rotate or more said rotating block, thereby adjusting said defined zone of coverage, to target and/or aim said at least one laser transmitter and said at least one laser sensor at said orientation parameters and to track said intruder.

Reflections from objects within, and potentially from beyond, the specified volume are received at LADAR sensor 202 and are converted into respective LADAR signals. Following conversion, the LADAR signals may be filtered and/or enhanced by a de-noising process implemented by de-noising module 220. The filtered signals may then be assessed by a decision function implemented by detection module 230, the decision function discriminating the processed reflections and determining whether they belong to an intruder or irrelevant target. The discrimination may be made in relation to a threshold, said threshold being one of mobility, range or appearance. In the case they do belong to an intruder, respective orientation (PTZ) parameters 240 associated with the direction and location of the intruder may be derived and may be applied to a driver 205 mechanically coupled to the or each rotating block.

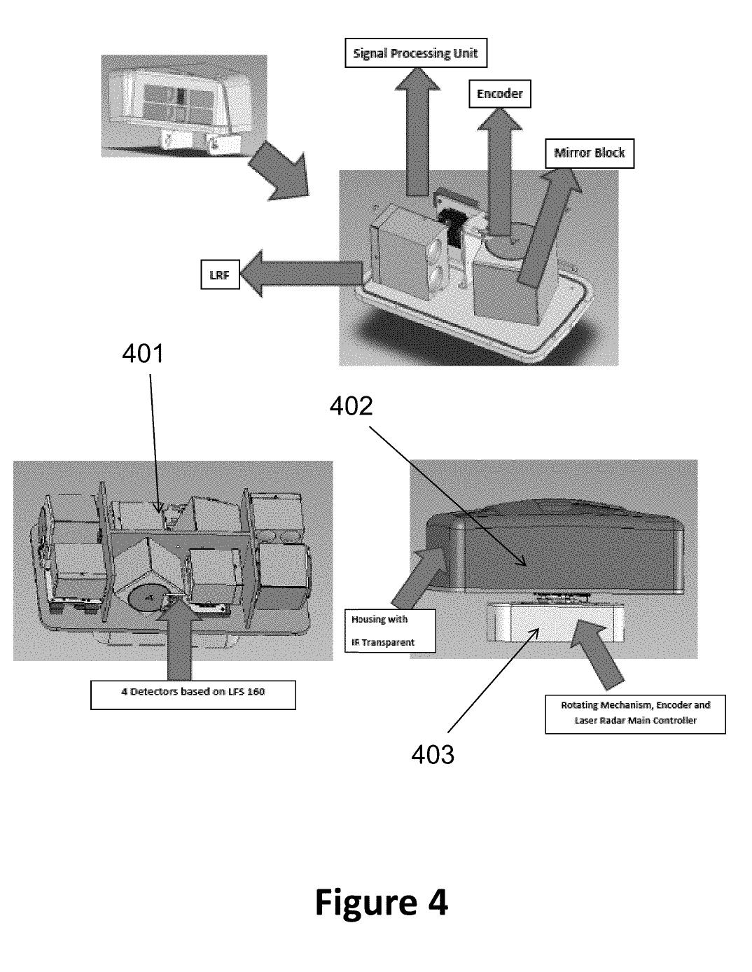

The bearing of rotating block 203, which is described in further detail in the description relating to FIG. 4, may be adjusted by driver 205. This is to say that driver 205 may be actuated by computer processor 210 to adjust the bearing of rotating block 203 and thereby also adjust and vary the zone of coverage exhibited by the or each associated sensor and transmitter pair. Variations to the bearing may be made during ordinary scanning procedures to improve coverage, or following intruder detection for the purposes of targeting and tracking said intruder. In the event that an intruder is identified and tracked, raw data concerning the intruder's mobility, appearance, trajectory and bearings may be compiled and stored. This raw data may then be conveyed to an analysis module 250 where further recognition and enhancement may be carried out. Tracking parameters 290 are then derived in real time so that driver 205 may be continually actuated to retain intruder 204 within the zone of coverage exhibited by the or each associated transmitter and sensor pair. The tracking parameters may be conveyed to a control unit 260 for use by an external entity (no shown here). Additionally, analysis module 250 may provide enhanced data to be presented over a display 270 to an operator 275 who can then provide his or her input via a user interface 280 to control unit 260. It will be appreciated by those skilled in the art that each of de-noising module 220, detection module 230, analysis module 250, control unit 260, display 270, user interface 280, laser transmitter 201, and laser sensor 202 may be physically or wirelessly connected to computer processor 210.

The purpose of LADAR device 200 is to illuminate incoming threats, but other objects, such as buildings, are still detected in the form of environmental noise. It will be appreciated by those skilled in the art that it is desirable for this environmental noise to be filtered out so as to reduce clutter and eliminate potential false alarms. It is therefore a task of the processing apparatus to filter out environmental noise by running a dedicated filtering computer program, which may be executed by the computer processor 210, said computer program being stored in a non-transitory computer readable medium. It may thus be said that the filtering program embodied in the computer-readable medium is dedicated to detect a relevant object, such as intruder 204 having the level of danger of being a threat, out of many objects penetrating into or existing within the specified volume scanned by the LADAR device 200. An algorithm implemented by the aforementioned computer readable code may use filtering trends and parameters to calculate variable and/or dynamic discrimination thresholds. For example, if the specified volume is observed to have greater irrelevant target activity during certain times of the day, the discrimination threshold may be adjusted accordingly.

According to some embodiments of the present invention, predefined criteria for determining a presence of an intruder in specific orientation parameters comprise a level of an integral of two of the LADAR signals measured in different times for the specific orientation parameters.

According to some embodiments of the present invention, orientation parameters comprise an orientation a line of sight of the LADAR whenever the line of sight intersects an object determined to be an intruder.

According to some embodiments of the present invention, comprising a control unit configured to instruct an external entity based on the tracking parameters.

According to some embodiments, computer processor 210 may be configured to apply at least one de-noising filter to said LADAR signals prior to determining the presence of the intruder 204.

According to some embodiments, computer processor 210 may be configured to run a dedicated filtering program to filter out environmental noise, said environmental noise being related to static, inanimate or permanent objects within said specified volume.

According to some embodiments, computer processor 210 may be further configured to discriminate said LADAR signals to distinguish between intruders and irrelevant targets, the discrimination being made in relation to a threshold where said threshold is at least one of mobility, range and appearance.

According to some embodiments, said mobility comprises at least one of: speed, acceleration, and vector of advancement, said appearance comprises at least one of: shape, color, and size, and said range is defined in relation to said specified volume.

According to some embodiments, computer processor 210 may be further configured to use filtering trends and parameters to calculate dynamic discrimination thresholds.

According to some embodiments, tracking parameters relating to a determined intruder are derived from raw data concerning said intruder's mobility, appearance, trajectory and bearings.

According to some embodiments, LADAR device 200 may further comprise a display 270, wherein said computer processor 210 is configured to present continuously on said display 270 enhanced data relating to said intruder, said continuous presentation persisting while said intruder is tracked within said specified volume.

According to some embodiments, each laser transmitter 201 and laser sensor 202 pair may be configured to periodically scan through a respective defined 2D zone of coverage with a laser beam produced by said at least one laser transmitter 201, said defined 2D zone of coverage being a portion of an intangible external surface encompassing said volume. Further, each laser sensor 202 may be configured to collect reflections of the laser beam arriving from objects crossing the defined 2D zone of coverage, said reflections arriving from irrelevant objects (not shown) or from a potential intruder 204. Reflections observed at the or each laser sensor 202 may be converted into LADAR signal indicative of the spatiotemporal presence of objects entering the specified volume, the LADAR device 200 being operable to ignore reflections originating from objects outside said specified volume. It will be appreciated by those skilled in the art that scanning through a defined 2D zone of coverage (i.e. a portion of a shell surrounding the specified volume) may be significantly quicker and more energy efficient than scanning through a full defined 3D zone of coverage. Further, if an intruder 204 is detected entering the specified volume, the LADAR device 200 may switch to scanning a defined 3D zone of coverage, or may track the intruder 204 directly within the specified volume.

According to some embodiments, computer processor 210 may be configured to apply black target algorithms to the LADAR signals to detect low reflective targets, said black target algorithms analyzing the contrast between intruder 204 signals and background signals. Black target algorithms may be applied continuously to all obtained LADAR signals, or may be applied only to a sample of signals over a preset or variable sampling period. It will be appreciated by those skilled in the art that ambient conditions, such as ambient weather conditions, may affect target reflectivity. In some embodiments, computer processor 210 may be physically or wirelessly connected to an ambient condition sensor, said ambient condition sensor operable to determine current ambient conditions and to inform said computer processor 210. In some embodiments, black target algorithms may be applied in relation to the determined current ambient condition, said black target algorithms accounting for reflectivity variations arising due to the current ambient condition.

According to some embodiments, zones within the specified volume may be designated with priority bands, said zones having 2D or 3D dimensions. Priority bands may include a no priority, low priority, medium priority, and high priority band, wherein each priority band defines an associated zone scanning frequency and/or intruder 204 determination threshold. In some embodiments, a no priority band may be associated with a zone of limited value within the specified volume, said no priority band defining an absence of scanning, a limited scanning frequency, an absence of intruder 204 detection determination, and/or a substantially increased intruder 204 determination threshold. In some embodiments, a high priority band may be associated with a zone of high value within the specified volume, said high priority band defining increased scanning frequency, continuous scanning, an increased intruder 204 determination threshold, and/or assumed intruder 204 determination. It will be appreciated by those skilled in the art that priority bands may be used to define zones within the specified volume where the presence of an intruder 204 should not raise alarm or flag attention, or where the presence of an intruder 204 highlights a significant or immediate security threat. By associating priority bands with zones within the specified volume, valuable assets may be more attentively protected and unnecessary scanning may be reduced thereby improving LADAR device 200 energy and cost efficiency. The process of associating priority bands with zones within the specified volume may be predominantly or entirely software implemented, and may be referred to by those skilled in the art as ‘masking’.

According to some embodiments, zones within the specified volume may be defined by preset, dynamic and/or user variable 2D or 3D co-ordinates, said co-ordinates lying within the specified volume. In some embodiments, said co-ordinates may be established using GPS instrumentation, such GPS locator tags and/or GPS triangulation methodology. In alternative embodiments, zones within the specified volume may be defined by an individual and/or an unmanned ground vehicle (UGV) tracing the boundaries of said zone, said individual or UGV being tracked by GPS and/or by LADAR device 200. In the case of the individual or UGV being tracked by the LADAR device 200, LADAR signals reflected from the individual or UGV may be collected and stored in a signal processing memory device, said signal processing memory device being physically or wirelessly connected to the computer processor 210. It will be appreciated by those skilled in the art that the signal processing memory device may be accessed by the computer processor 210 at any appropriate time to establish the presence and/or boundaries of zones within the specified volume.

According to some embodiments, the beam pulse frequency emitted from laser transmitter 201 and/or the scanning frequency of laser sensor 202 may be dynamically varied in relation to signal discrimination. It will be appreciated by those skilled in the art that the Johnson Criteria applies to LADAR target discrimination. This is to say that a target may be detected (i.e. presence determined) from relatively few LADAR signals (2-3 signals, for example), however orientation (symmetrical, asymmetrical, horizontal or vertical), recognition (type of object e.g. car or person) and identification (discerning object features e.g. specific car, or man versus woman) require successively more LADAR signals to ascertain. By varying the beam pulse and/or scanning frequency following initial target detection, further LADAR signals may be more quickly obtained to facilitate further discrimination of the target. In some embodiments, the beam pulse and/or scanning frequency may be increased and/or decreased during the signal discrimination process following initiate intruder 204 determination. In some embodiments, the beam pulse and/or scanning frequency may be increased and/or decreased when signal discrimination has completed and when the intruder's appearance and mobility have been determined. In some embodiments, the intruder 204 may be tracked by the or each LADAR transmitter 201 and sensor 202 pair until the discrimination process has completed. In some embodiments, the LADAR device 200 may resume standard and/or ordinary scanning procedures following completion of the intruder 204 discrimination process.

According to some embodiments, LADAR device 200 may comprise a signal amplifier and an analogue to digital (A/D) converter. In some embodiments, a signal pulse associated with a prospective intruder 204 (i.e. the signal pulse arising as a result of a beam emitted from transmitter 201 reflecting from an intruder 204 and being detected by sensor 202) may be amplified by the signal amplifier and converted from analogue to digital by the A/D converter. In some embodiments, the processed signal (i.e. the amplified and converted signal) may be assessed in relation to a comparator and peak detector implemented by computer processor 210. In some embodiments, the comparator followed by the time to voltage and A/D measures the time of flight at the instant the signal pulse is detected. This is a measure of the uncorrected range. In some embodiments, the peak followed by the A/D measures signal pulse amplitude. It will be appreciated by those skilled in the art that the uncorrected range depends on pulse amplitude. In some embodiments, the function Racorrected=F(Runcorrected, Amplitude) may be implemented by a signal processing algorithm and/or the computer processor 210 to yield corrected range.

According to some embodiments, LADAR device 200 may comprise or be used in conjunction with one or more of the following: Dr. Frucht Systems Limited (DFSL) Laser Rader technology; DFSL Smart Sense; DFSL AI; DFSL Long Fence Protection; DFSL Vertical and/or Parallel Laser Curtain technology; DFSL Integration Software—ISSC; DFSL Laser Radar (Lidar) Sensors; DFSL 2D Mini-Drone-Detector; DFSL 3D Mini-Drone-Detector; DFSL Anti-Drone; DFSL Flying-Hunter; DFSL Defender; DFSL Know-How; DFSL IPI Software; DFSL Home and Pool Safety; DFSL Land Security; DFSL Algorithms and Installation Procedures; DFSL HLS Products; DFSL PLS200-35/60; DFSL LFS-60/100/130; DFSL PLS 360-60/100; DFSL LFS-160; DFSL 2D-MND-200-48-PTZ; DFSL ALS-200/350; DFSL Over Height Vehicle Laser Detector (OHVLD); and, DFSL Laser Scanner Mobile Case.

According to some embodiments, LADAR device 200 may be used or applied for one or more of the following: securing long fences; securing open areas; securing roof tops; swimmer and ship detection; obstacle avoidance and anti-piracy at sea; marina protection; drone detection; intruder detection; securing infrastructure; drone interception and capture; railway cross road safety; railway track security; train station platform detection; landing aircraft security; securing water reservoirs; power plant repair and construction; creating sterile areas; construction safety; virtual safety curtain; home safety; detection of falling objects; over height vehicle detection; pool safety; and, prison security.

FIG. 3 is a block diagram illustrating non-limiting exemplary architecture of a swing mirror LADAR detector arrangement in accordance with embodiments of the present invention. In a standard setting, the or each LADAR sensor and transmitter pair is aligned to exhibit a substantially identical zone of coverage. The larger this zone of coverage, the longer each scanning cycle takes and the greater the scanning latency. This, in turn, gives rise to the potential delay in identifying intruders that have entered said zone of coverage. In practice, therefore, the zone of coverage of the or each sensor and transmitter pair is matched appropriately with their scanning frequency. This may, by way of example, mean that each sensor and transmitter pair is restricted to a 60° scanning arc, and to achieve full hemispherical dome coverage a set of three interconnected LADAR sensor and transmitter pairs would be required.

In order to overcome this limitation, the present invention proposes a LADAR device arrangement further comprising a swing mirror, said swing mirror comprising a substantially mirrored surface 301 and a tilt mechanism 302. Tilt mechanism 302 may be driven by driver 105, may be motorised or hand actuated, and may further be adjusted in relation to orientation (PTZ) parameters of an intruder. Light reflected by a potential intruder may be detected either directly by the sensor, or following an additional reflection upon the substantially mirrored surface 301. The tilt angle of the substantially mirrored surface 301 may also be adjusted by the tilt mechanism 302 to obtain an additional or alternative zone of coverage. The tilt angle of the substantially mirrored surface 301 may be adjusted periodically or incrementally, during or between scanning cycles. The tilt angle of the substantially mirrored surface 301 may be varied as a consequence of identifying a potential intruder, or as a matter of course to improve coverage during ordinary scanning procedures. In the event that an intruder is detected, the tilt angle of the substantially mirrored surface 301 may be continually adjusted in relation to orientation parameters of the intruder. The tilt angle of the substantially mirrored surface 301 may be varied to retain coverage of an intruder, thereby facilitating tracking of the intruder within the specified volume.

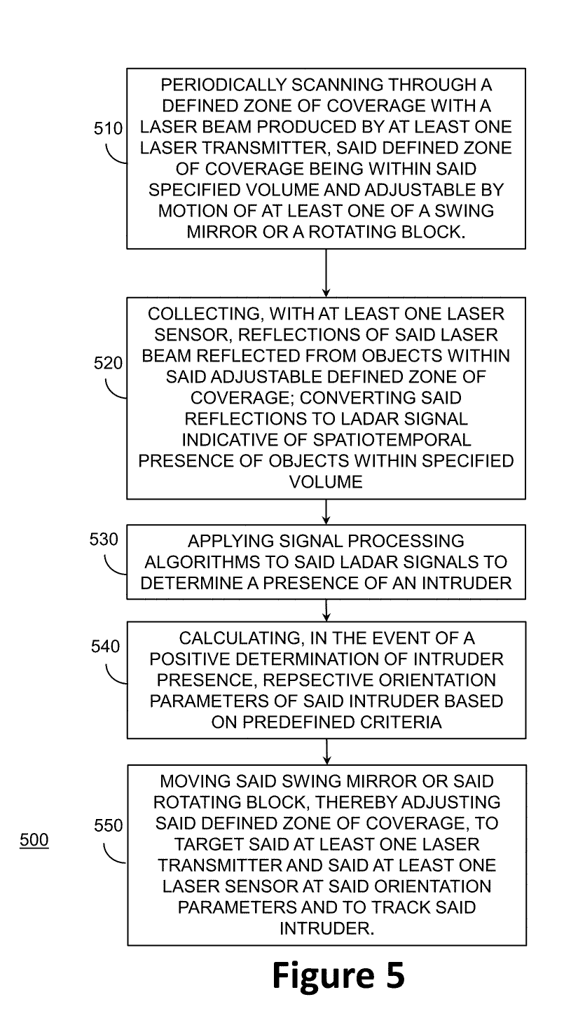

FIG. 4 is a block diagram illustrating non-limiting exemplary architecture of a rotating block LADAR detector arrangement in accordance with embodiments of the present invention. In an alternative approach to improving coverage, the present invention also proposes a LADAR device arrangement further comprising a rotating block, said rotating block comprising a housing 402 and a rotating mechanism 403. In such arrangements, one or more transmitter and sensor pairs 401 may be statically mounted into the housing 402 of a rotating block. Each transmitter and sensor pair 401 will exhibit a predefined zone of coverage relative to the rotating block. In some embodiments, the rotating block may feature a plurality of transmitter and sensor pairs 401, each with a substantially separate zone of coverage. Such an arrangement is depicted in FIG. 5 where four transmitter and sensor pairs 401 are shown. When a variation in coverage is required, such as when an intruder is detected or when ordinary scanning procedures are underway, the rotating block may be turned by rotating mechanism 403. The rotating block may be turned periodically or incrementally, during or between scanning cycles. As the rotating block moves, the zone of coverage exhibited by the or each transmitter and sensor pair 401 is adjusted accordingly. The rotating block may be turned about a clockwise or anticlockwise direction. In some embodiments, the rotating block may also tilt about its axis. In yet further embodiments, the rotating block may move about three degrees of freedom. In the event that an intruder is detected, the bearing of the rotating block may be continually adjusted in relation to orientation parameters of the intruder. The bearing of the rotating block may be varied to retain coverage of an intruder, thereby facilitating tracking of the intruder within the specified volume.

FIG. 5 is a high level flowchart illustrating a non-limiting exemplary method 500 in accordance with embodiments of the present invention. Method 500 of targeting and tracking an intruder within a specified volume may include the following steps: periodically scanning through a defined zone of coverage with a laser beam produced by at least one laser transmitter, said defined zone of coverage being within said specified volume and adjustable by motion of at least one of a swing mirror or a rotating block 510; collecting, with at least one laser sensor, reflections of said laser beam reflected from objects within said adjustable defined zone of coverage; converting said reflections to LADAR signal indicative of spatiotemporal presence of objects within said specified volume 520; applying signal processing algorithms to said LADAR signals to determine a presence of an intruder 530; calculating, in the event of a positive determination of intruder presence, respective orientation parameters of said intruder based on predefined criteria 540; and moving said swing mirror or said rotating block, thereby adjusting said defined zone of coverage, to target said at least one laser transmitter and said at least one laser sensor at said orientation parameters and to track said intruder 550.

In order to implement method 500 according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, some aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination.

Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for targeting and tracking an intruder within a specified volume, the system comprising:
a laser detection and ranging (LADAR) device comprising: at least one laser transmitter, at least one laser sensor, and at least one of a swing mirror or a rotating block, said LADAR device configured to:
periodically scan through a defined zone of coverage with a laser beam produced by said at least one laser transmitter, said defined zone of coverage being within said specified volume and adjustable by motion of said swing mirror or said rotating block;
collect, with said at least one laser sensor, reflections of said laser beam reflected from objects within said adjustable defined zone of coverage;
convert said reflections to LADAR signal indicative of spatiotemporal presence of objects within said specified volume;
a computer processor configured to apply signal processing algorithms to said LADAR signals to determine a presence of an intruder and, in the event of a positive determination of intruder presence, to calculate respective orientation parameters of said intruder based on predefined criteria; and
wherein said computer processor is further configured to move said swing mirror or said rotating block, thereby adjusting said defined zone of coverage, to target said at least one laser transmitter and said at least one laser sensor at said orientation parameters and to track said intruder.

2. The system according to claim 1, wherein the computer processor is configured to apply at least one de-noising filter to said LADAR signals prior to determining the presence of the intruder.

3. The system according to claim 1, wherein said computer processor is configured to run a dedicated filtering program to filter out environmental noise, said environmental noise being related to static, inanimate or permanent objects within said specified volume.

4. The system according to claim 1, wherein said predefined criteria for determining a presence of an intruder in specific orientation parameters comprise a level of an integral of two of the LADAR signals measured in different times for said specific orientation parameters.

5. The system according to claim 3, wherein the computer processor is further configured to discriminate said LADAR signals to distinguish between intruders and irrelevant targets, the discrimination being made in relation to a threshold where said threshold is at least one of mobility, range and appearance.

6. The system according to claim 5, wherein said mobility comprises at least one of: speed, acceleration, and vector of advancement, wherein said appearance comprises at least one of: shape, color, and size, and wherein said range is defined in relation to said specified volume.

7. The system according to claim 1, wherein said orientation parameters comprise an orientation a line of sight of said LADAR whenever said line of sight intersects an objected determined to be an intruder.

8. The system according to claim 5, wherein said computer processor is further configured to use filtering trends and parameters to calculate dynamic discrimination thresholds.

9. The system according to claim 1, wherein tracking parameters relating to a determined intruder are derived from raw data concerning said intruder's mobility, appearance, trajectory and bearings.

10. The system according to claim 9, further comprising a display, wherein said computer processor is configured to present continuously on said display enhanced data relating to said intruder, said continuous presentation persisting while said intruder is tracked within said specified volume.

11. A method of targeting and tracking an intruder within a specified volume, the method comprising:
periodically scanning through a defined zone of coverage with a laser beam produced by at least one laser transmitter, said defined zone of coverage being within said specified volume and adjustable by motion of at least one of a swing mirror or a rotating block;
collecting, with at least one laser sensor, reflections of said laser beam reflected from objects within said adjustable defined zone of coverage;
converting said reflections to LADAR signal indicative of spatiotemporal presence of objects within said specified volume;
applying signal processing algorithms to said LADAR signals to determine a presence of an intruder;
calculating, in the event of a positive determination of intruder presence, respective orientation parameters of said intruder based on predefined criteria;
and, moving said swing mirror or said rotating block, thereby adjusting said defined zone of coverage, to target said at least one laser transmitter and said at least one laser sensor at said orientation parameters and to track said intruder.

12. The method according to claim 11, further comprising applying at least one de-noising filter to said LADAR signals prior to determining the presence of the intruder.

13. The method according to claim 11, further comprising running a dedicated filtering program to filter out environmental noise, said environmental noise being related to static, inanimate or permanent objects within said specified volume.

14. The method according to claim 11, wherein said predefined criteria for determining a presence of an intruder in specific orientation parameters comprise a level of an integral of two of the LADAR signals measured in different times for said specific orientation parameters.

15. The method according to claim 13, further comprising discriminating said LADAR signals to distinguish between intruders and irrelevant targets, the discrimination being made in relation to a threshold where said threshold is at least one of mobility, range and appearance.

16. The method according to claim 15, wherein said mobility comprises at least one of: speed, acceleration, and vector of advancement, wherein said appearance comprises at least one of: shape, color, and size, and wherein said range is defined in relation to said specified volume.

17. The method according to claim 11, wherein said orientation parameters comprise an orientation a line of sight of said LADAR whenever said line of sight intersects an objected determined to be an intruder.

18. The method according to claim 15, further comprising using filtering trends and parameters to calculate dynamic discrimination thresholds.

19. The method according to claim 11, wherein tracking parameters relating to a determined intruder are derived from raw data concerning said intruder's mobility, appearance, trajectory and bearings.

20. The method according to claim 19, further comprising presenting continuously, over a display, enhanced data relating to said intruder, said continuous presentation persisting while said intruder is tracked within said specified volume.
